(19) United States
(12) Patent Application Publication
(10) Pub. No.: US 2008/0225261 A1
(43) Pub. Date: Sep. 18, 2008

(54) EXPOSURE APPARATUS AND DEVICE MANUFACTURING METHOD

(76) Inventor: Noriyuki Hirayanagi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/044,813

(22) Filed: Mar. 7, 2008

Related U.S. Application Data
(60) Provisional application No. 60/906,516, filed on Mar. 13, 2007.

(51) Int. Cl. G03B 27/58

(52) U.S. Cl. 355/72

(57) ABSTRACT

An exposure apparatus is configured so that a wafer carrier robot can deliver a wafer to a wafer holder held by a holder carrier robot or can carry out a wafer from the wafer holder held by the holder carrier robot, under a reduced-pressure environment. According to the apparatus, even if it takes a relatively long time to replace the wafer on the wafer holder used inside the reduced pressure space, by performing the wafer exchange operation and a predetermined operation (the exposure apparatus main section operation) using the stage on which the wafer holder holding the wafer is mounted concurrently, the influence that the wafer exchange time has on the throughput can be suppressed.

### CROSS-REFERENCE TO RELATED APPLICATIONS

This non-provisional application claims the benefit of Provisional Application No. 60/906,516 filed Mar. 13, 2007, the disclosure of which is hereby incorporated herein by reference in its entirety.

### BACKGROUND OF THE INVENTION

1. Field of the Invention

The present invention relates to exposure apparatus and device manufacturing methods, and more particularly to an exposure apparatus which exposes an object with an energy beam, and a device manufacturing method which uses the exposure apparatus.

2. Description of the Background Art

Conventionally, in a lithography process for manufacturing semiconductor devices such as ICs (integrated circuits), a projection exposure apparatus that transfers a pattern of a mask or a reticle on a wafer via a projection optical system, such as, for example, a reduction projection exposure apparatus (so-called stepper) by the step-and-repeat method, a reduction projection exposure apparatus (so-called scanning stepper) by the step-and-scan method and the like are used. Recently, development of a EUV exposure apparatus that uses light (EUV (Extreme Ultraviolet) light) in the soft X-ray region having the wavelength of 5 to 50 nm as the exposure light is being performed. In this EUV exposure apparatus, because EUV light is used as the exposure light, the main part of the exposure apparatus main section is housed in a vacuum chamber whose inside is a vacuum. Therefore, a wafer holder by the vacuum chuck method cannot be used as the wafer holder for holding a wafer on a wafer stage, so a wafer holder by the electrostatic chuck method is used which holds the wafer by an electrostatic force as is disclosed in, for example, U.S. Patent Application Publication No. 2005/0286202 description.

However, the wafer holder by the electrostatic chuck method has a longer response time when compared to the vacuum chuck. More specifically, the wafer holder by the electrostatic chuck method requires a relatively long time after placing a wafer on a wafer holder until electrostatic force has been started and a predetermined adhesion force is obtained, and also requires a relatively long time after finishing (releasing) the electrostatic force until a wafer becomes removable, when recovering the wafer from the wafer holder. Accordingly, there is a concern of the response time of these electrostatic chucks decreasing the throughput of the exposure apparatus.

### SUMMARY OF THE INVENTION

The present invention was made under the circumstances described above, and according to a first aspect there is provided an exposure apparatus that exposes an object with an energy beam and forms a pattern on the object, the apparatus comprising: an object carrier system which carries an object under a reduced-pressure environment; an object stage on which a holding device that holds the object is mounted under a reduced-pressure environment; and a holding device carrier system which temporarily holds the holding device that holds the object and can receive/pass the object from/to the stage under a reduced-pressure environment.

According to this apparatus, the object carrier system can carry an object to the holding device that the holding device carrier system holds, or can carry out an object from the holding device that the holding device carrier system holds under a reduced-pressure environment. That is, the object carrier system makes it possible to perform object exchange on the holding device held by the holding device carrier system. Accordingly, even if it takes a relatively long time to exchange the object on the holding device (for example, a holding device that holds an object by electrostatic force) used in a reduced-pressure space, the influence that the object exchange time has on throughput can be suppressed by concurrently performing the object exchange operation and a predetermined operation (an exposure apparatus main section operation) that is performed using the object stage on which the holding device holding the object is mounted.

Further, according to a second aspect of the present invention, there is provided a device manufacturing method, including: exposing a substrate using the exposure apparatus described above; and developing a substrate which has been exposed.

### BRIEF DESCRIPTION OF THE DRAWINGS

In the accompanying drawings;

FIG. 1 is a view that schematically shows a configuration of an exposure apparatus in an embodiment;

FIG. 2 is a schematic view that shows a configuration of an exposure apparatus main section;

FIG. 3A is a planar view showing a wafer holder, FIG. 3B is a view showing wiring for an electrostatic chuck arranged in a wafer holder and a wafer stage, and FIG. 3C is planar view showing a state where a wafer is mounted on a wafer holder;

FIG. 4A is a view for explaining a configuration of a wafer exchange section, FIG. 4B is a view for explain a mounting method of a wafer in the wafer exchange section, and FIG. 4C is a perspective view showing a second prealignment device arranged in the wafer exchange section;

FIGS. 5A and 5B are views (No. 1) for explaining a series of operations of an exposure apparatus related to an embodiment;

FIGS. 6A and 6B are views (No. 2) for explaining a series of operations of an exposure apparatus related to an embodiment;

FIG. 7 is a schematic view that shows a configuration of an exposure apparatus related to another embodiment; and

FIG. 8A is planar view showing a wafer holder related to another embodiment, and FIG. 8B is a view showing wiring for an electrostatic chuck arranged in a wafer holder and a wafer stage related to another embodiment.

### DESCRIPTION OF THE EMBODIMENTS

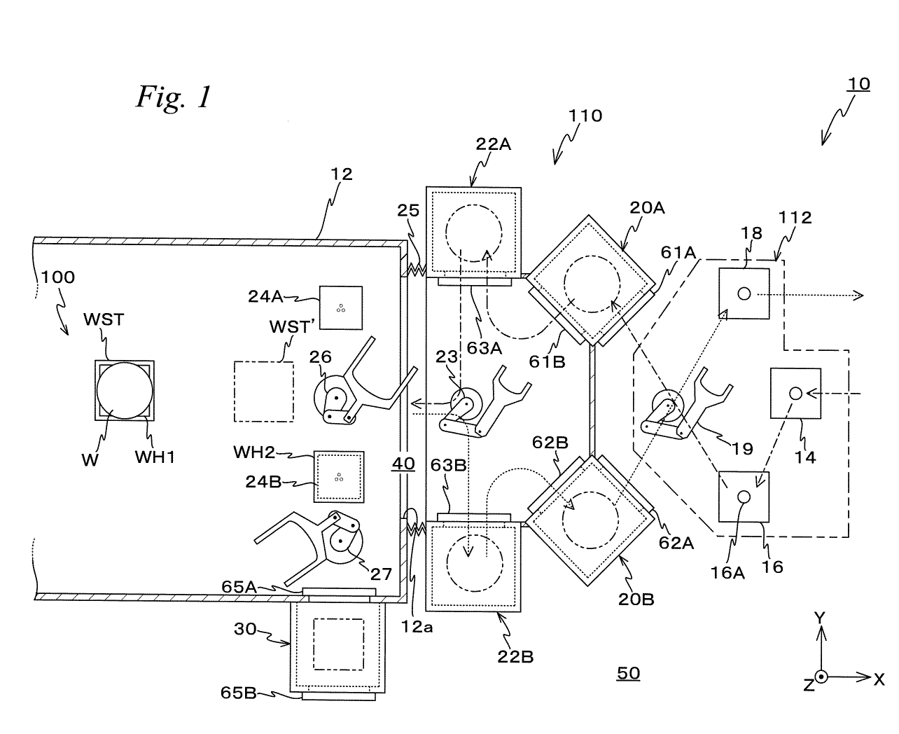

Hereinafter, an exposure apparatus 10 related to an embodiment of the present invention will be described, referring to FIGS. 1 to 6B.

FIG. 1 shows a planar view of a schematic configuration of exposure apparatus 10 related to the embodiment. Exposure apparatus 10 is equipped with an atmospheric carrier system 112 placed in an atmospheric pressure space 50, a vacuum carrier system 110 placed on the −X side of atmospheric carrier system 112, and a main body chamber 12 placed on the −X side of vacuum carrier system 110.

Between vacuum carrier system 110 and an opening 12a section of main body chamber 12, a bellows 25 is arranged, and an enclosed space (airtight space) 40 is formed by main body chamber 12, vacuum carrier system 110, and bellows 25. The inside of enclosed volume 40 is to be in a vacuum state by a vacuum pump (not shown). In the description below, this space 40 shall be referred to as a “vacuum space 40”. Further, because vacuum carrier system 110 and main body chamber 12 are connected with bellows 25 having a high elasticity, vacuum carrier system 110 and main body chamber 12 are in a substantially separated state vibrationwise.

Atmospheric carrier system 112 is equipped with a wafer delivery section 14 on which a wafer carried from coater developer (not shown) is mounted, a first prealignment device 16 arranged in the vicinity of the −X side an the −Y side of wafer delivery portion 14, a wafer discharge section 18 on which the wafer that has undergone the exposure process and is to be carried out to the coater developer is mounted temporarily, an atmospheric carrier robot 19 made up of a horizontal multiple-joint robot (a SCARA robot) that can move vertically (linear movement in the Z-axis direction).

The first prealignment device 16 has a turntable 16A which can move in the XY direction and can rotate around the Z-axis. In the first prealignment device 16, eccentricity (shift in the XY direction) and shift in the rotational direction of the wafer are detected using a line sensor (not shown) or the like, and based on the detection results, the position and/or the rotation of the wafer are adjusted using turntable 16A. Incidentally, the wafer can be picked up using atmospheric carrier robot 19, and the wafer can be mounted on turntable 16A again after the position and/or the rotation of the wafer have been adjusted. In this case, turn table 16A does not necessarily have to be arranged in the first prealignment device 16.

Atmospheric carrier robot 19 carries the wafer between wafer delivery section 14 and the first prealignment device 16, the first prealignment device 16 and a load lock chamber 20A which will be described later on, and a load lock chamber 20B which will be described later on and wafer discharge section 18.

Vacuum carrier system 110 is equipped with a vacuum carrier robot 23 made up of load lock chambers 20A and 20B, stockers 22A and 22B, and a horizontal multiple-joint robot (a SCARA robot) that can move vertically (linear movement in the Z-axis direction).

Load lock chamber 20A has a door 61A of an atmospheric space 50 side and a door 61B of a vacuum space 40 side, and has shelves (not shown) arranged inside that can hold a predetermined number of wafers. Under instructions of a controller (not shown), in a state where doors 61A and 61B are closed, load lock chamber 20A can set its inner space into a vacuum state or to an atmospheric pressure state. In a state where door 61A of load lock chamber 20A is open, atmospheric carrier robot 19 can have access into load lock chamber 20A. On the other hand, in a state where door 61B is open, vacuum carrier robot 23 can have access into load lock chamber 20A.

Similar to load lock chamber 20A, load lock chamber 20B has a door 62A of an atmospheric space 50 side and a door 62B of a vacuum space 40 side, and has shelves (not shown) arranged inside that can hold a predetermined number of wafers. Under instructions of the controller (not shown), in a state where doors 62A and 62B are closed, load lock chamber 20B can set its inner space into a vacuum state or to an atmospheric pressure state. With load lock chamber 20B, access to the inside by atmospheric carrier robot 19 and vacuum carrier robot 23 is possible, similar to load lock chamber 20A described above.

Doors 61A and 61B, and 62A and 62B are doors that separate the vacuum space and the atmospheric space, and as these doors, gate valves or the like can be used.

Stocker 22A has a door 63A that can be opened or closed, and inside stocker 22A, shelves (not shown) are arranged to house a predetermined number of wafers. In the inside of stocker 22A, although it is not shown, a temperature control device for controlling the temperature of the wafer is arranged.

Stocker 22B has a door 63B that can be opened or closed, and inside stocker 22B, shelves (not shown) are arranged to house a predetermined number of wafers which have been exposed.

Incidentally, two stockers 22A and 22B are used here; however, it is possible for one stocker to have the functions of the two stockers. Furthermore, three or more stockers can be placed, or it can be decided that stockers will not be used.

Vacuum carrier robot 23 carries a wafer between load lock chamber 20A and stocker 22A, stocker 22A and main body chamber 12 (to be more precise, wafer exchange device 24A or 24B to be described below), main body chamber 12 (to be fore precise, wafer exchange device 24B or 24A to be described below) and stocker 22B, and stocker 22B and load lock chamber 20B. Incidentally, in FIG. 1, a single hand type robot is employed as vacuum carrier robot 23; however, a double hand type robot can also be employed.

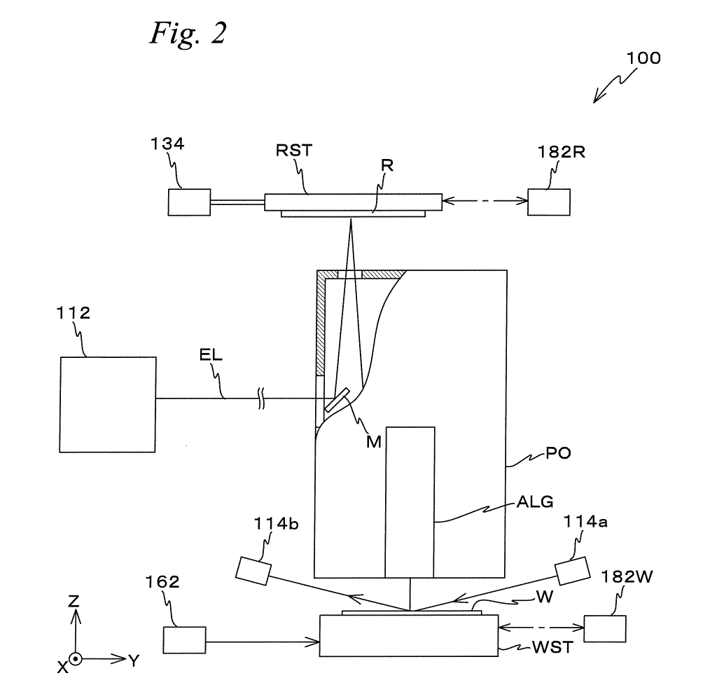

In the inside of main body chamber 12, an exposure apparatus main section 100 (FIG. 1 shows only wafer stage WST configuring exposure apparatus main section 100, refer to FIG. 2), and a first holder carrier robot 26, wafer exchange sections 24A and 24B, and a second holder carrier robot 27 are installed.

The first holder carrier robot 26 is made up of a horizontal multiple-joint robot (a SCARA robot) that can move vertically (linear movement in the Z-axis direction), and is placed at a position a predetermined distance away from exposure apparatus main section 100 on the +X side. Wafer exchange sections 24A and 24B are placed on the +Y side and the −Y side of the first holder carrier robot 26, respectively. The second holder carrier robot 27 is made up of a horizontal multiple-joint robot (a SCARA robot) that can move vertically (linear movement in the Z-axis direction), and is placed on the −Y side of wafer exchange section 24B. Further, on the −Y side of main body chamber 12, a load lock chamber 30 for holders is arranged.

As shown in FIG. 2, for example, by relatively scanning a reticle R and a wafer W in a one-dimension direction (in this case, the Y-axis direction) with respect to projection optical system PO while projecting a part of a circuit pattern formed on a reticle via projection optical system PO on wafer W, exposure apparatus main section 100 transfers the entire circuit pattern of reticle R onto each of a plurality of shot areas on wafer W by the step-and-scan method.

Exposure apparatus main section 100 is equipped with an illumination optical system including a bending mirror M which reflects an EUV light EL from light source device 112 arranged outside chamber 12 and bends the light so that the light is incident on a pattern surface (the lower surface in FIG. 2 (the surface on the −Z side)) of reticle R at a predetermined incidence angle, such as, for example, around 50 [mrad], a reticle stage RST that holds reticle R, a projection optical system PO that perpendicularly projects EUV light EL reflected off the pattern surface of reticle R on a surface of wafer W subject to exposure (the upper surface in FIG. 1 (the surface on the +Z side)), and a wafer stage WST that holds wafer W and the like.

As light source device 112, a laser-excited plasma light source is used as an example. By irradiating a laser beam with high brightness to a EUV light generation material (a target), the target is excited into a high-temperatured plasma state, and the laser-excited plasma light source uses the EUV light released from the plasma. Incidentally, in the embodiment, EUV light mainly having the wavelength of 5 to 50 nm, such as, for example, a EUV light EL of 11 nm, will be used as the exposure beam.

The illumination optical system includes an illumination mirror, a wavelength selection window and the like (both of which are omitted in the drawings), and bending mirror M and the like. Further, a parabolic mirror which is a light condensing mirror placed inside light source device 112 also configures a part of the illumination optical system. EUV light EL (EUV light EL reflected off bending mirror M previously described) emitted from light source device 112 via illumination optical system becomes an arc, slit-shaped illumination light and illuminates the pattern surface of reticle R.

Reticle stage RST is driven in the Y-axis direction in a predetermined stroke by a drive force generated by a reticle stage drive system 134, and is also finely driven in the X-axis direction and the θz direction (a rotating direction around the Z-axis). Further, reticle stage RST is configured drivable only minutely in the Z-axis direction and a direction of inclination (the θx direction which is a rotating direction around the X-axis and the By direction which is a rotating direction around the Y-axis) with respect to an XY plane by adjusting the magnetic levitation force which reticle stage drive system 134 generates at a plurality of points. On the lower surface side of reticle stage RST, a reticle holder (not shown) by an electrostatic chuck method (or a mechanical chuck method) is arranged, and reticle R is held by the reticle holder. As reticle R, a reflection type reticle is used, corresponding to the point that illumination light EL is an EUV light having a wavelength of 11 nm. Reticle R is held by the reticle holder in a state so that the pattern surface serves as a bottom surface.

Reticle R is made of a thin plate such as a silicon wafer, quartz, a low expansion glass and the like, and on its surface (pattern surface), a reflection film which reflects the EUV light is formed. This reflection film is a multilayer film on which, for example, a film of molybdenum Mo and beryllium Be are alternately layered at a period of around 5.5 nm for about 50 pairs. This multilayer film has around 70% reflectance to EUV light which has the wavelength of 11 nm. Incidentally, a multilayer film having a similar arrangement is also formed on the reflection surface of bending mirror M, each mirror of the illumination optical system, and each mirror in light source device 12.

On the multilayer film formed on the pattern surface of reticle R, for example, nickel Ni or aluminum Al is coated over the surface as an absorption layer, and patterning is applied on the absorption layer so as to form a circuit pattern. The EUV light which hits the part where the absorption layer of reticle R remains is absorbed by the absorption layer, and the EUV light which hits the reflection film of the part (the part that absorption layer was removed) where the absorption layer is removed is reflected by the reflection film, and as a consequence, the EUV light which includes the information of the circuit pattern proceeds toward projection optical system PO as a reflected light from the pattern surface of reticle R.

The position of reticle stage RST (reticle R) in the XY plane is constantly detected by a reticle interferometer 182R, which projects a laser beam on a reflection surface arranged (or formed) on reticle stage RST, at a resolution of, for example, around 0.5 to 1 nm. In this case, an interferometer for measuring the X position and an interferometer for measuring the Y position of reticle stage RST are actually arranged as the reticle interferometer, however, these are representatively shown as reticle interferometer 182R in FIG. 2.

The measurement values of reticle interferometer 182R are supplied to the controller (not shown), and the controller drives reticle stage RST via reticle stage drive system 134 based on the measurement values of reticle interferometer 182R.

As projection optical system PO, a catoptric system whose numerical aperture (N.A.) is, for example, 0.3, consists of only catoptric elements (mirrors), and in this case, has a projection magnification of ¼ times is used. Accordingly, EUV light EL, which is reflected by reticle R and includes the information of the pattern formed on reticle R, is projected on wafer W by projection optical system PO, and thus, a part of a reduced image of the pattern on reticle R is formed on wafer W.

Wafer stage WST is driven, for example, in the X-axis direction and the Y-axis direction with predetermined strokes by a wafer stage drive system 162 consisting of a magnetic levitation type two-dimensional linear actuator, and it also minutely driven in the θz direction (the rotational direction around the Z-axis). Further, wafer stage WST is also configured minutely drivable in the Z-axis direction, the θx direction (the rotating direction around the X-axis), and the θy direction (the rotating direction around the Y-axis) by wafer stage drive system 162.

The position of wafer stage WST is constantly detected by a wafer interferometer 182W arranged external to the stage, at a resolution of, for example, around 0.5 to 1 nm. In this case, an interferometer that has a measurement axis in the X-axis direction and an interferometer that has a measurement axis in the Y-axis direction are actually arranged, however, these are representatively shown as wafer interferometer 182W in FIG. 2. The interferometers are configured of a multiaxial interferometer which has a plurality of measurement axes, and besides the X, Y positions of wafer stage WST, rotation (yawing (θz direction), pitching (θx direction), and rolling (θy direction) can also be measured.

Further, the position of wafer W in the Z-axis direction with the barrel of projection optical system PO serving as a reference is measured, using a wafer focus sensor by an oblique incidence method. As shown in FIG. 2, this wafer focus sensor is configured of a light sending system 114a, which irradiates a detection beam from an oblique direction to the upper surface of wafer W, and a photodetection system 114b, which receives the detection beam reflected off the wafer W surface. As this wafer focus sensor (114a, 114b), a multipoint focal point position detection system whose details are disclosed in, for example, U.S. Pat. No. 5,448,332 description, is used.

The measurement values of wafer interferometer 182W and wafer focus sensor (114a, 114b) is supplied to the controller (not shown), and the controller controls wafer stage drive system 162 so that control of position in six-dimensional directions and attitude of wafer stage WST is performed.

On the upper surface of wafer stage WST, a wafer holder (wafer holder WH1 in FIG. 1) by the electrostatic chuck method is mounted, and the wafer holder (WH1) holds wafer W. Further, on the upper surface of wafer stage WST, wafer holder WH2 which is mounted on wafer exchange device 24B in FIG. 1 can be mounted.

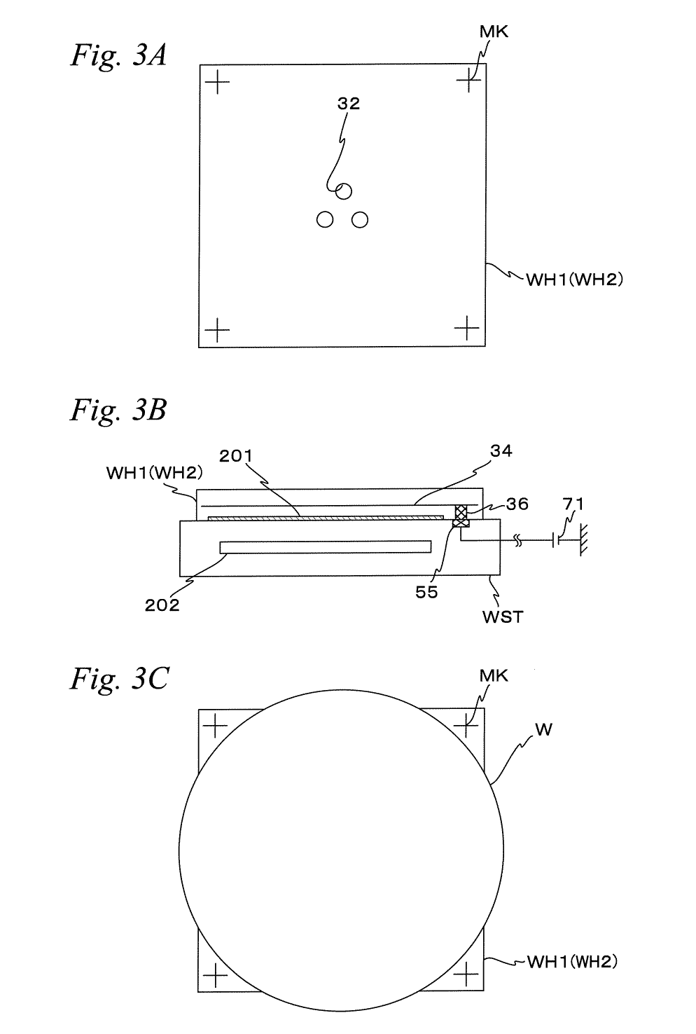

These wafer holders WH1 and WH2 have the same shape/configuration. As shown in FIG. 3A, wafer holder WH1 (WH2) consists of a plate-shape member of a rough square shape in a planar view (when viewing from the +Z direction), and the sides of the plate-shaped member are set slightly smaller than the diameter of wafer W (refer to FIG. 3C). Because the length of the sides of the wafer holder is set smaller than the diameter of wafer W, as it will be described later on, it becomes possible to detect the decentering quantity and rotation quantity of the wafer with a second prealignment device. As a matter of course, if a notch section is formed in a part of the wafer holder, the length of the sides does not have to be reduced. Further, the second prealignment device does not have to be placed. In the vicinity of the center section of wafer holder WH1 (WH2), three through-holes 32 are formed penetrating the center in a vertical direction (the Z-axis direction).

Further, on the upper surface of wafer holder WH1 (WH2), although it is not shown, a plurality of pin sections that support the wafer from the lower surface is arranged. The ratio of contact (the ratio of contact when the lower surface of wafer W serves as a reference) between the upper surface (the pin section) of wafer holder WH1 (WH2) and the lower surface of wafer W is set to around 20% or under. In order not to sandwich foreign materials between the wafer and wafer holder WH1 (WH2), a smaller ratio of contact is desirable; however, a ratio of contact around the level in which the wafer can be held even if wafer stage WST is accelerated is necessary. From such viewpoints, the ratio of contact is set to the range described above, based on the relation between the acceleration of wafer stage WST and the force of wafer holder WH1.

Further, as shown in FIG. 3B, in the inside of wafer holder WH1 (WH2), an internal electrode 34 for an electrostatic chuck is arranged, and a holder side electrical contact 36 connects to internal electrode 34. Incidentally, only one electrode is listed in FIG. 3B, however, an electrostatic chuck using a plurality of electrodes can also be used. Further, on the lower surface of wafer holder WH1 (WH2), a magnetic body 201 is arranged. And by the magnetic force (electromagnetic force) which occurs when applying electrical current to a coil 202 arranged within wafer stage WST, wafer holder WH1 (WH2) is fixed to wafer stage WST.

Meanwhile, as shown in FIG. 3B, on a part of the upper surface of wafer stage WST where holder side electrical contact 36 is in contact in a state where wafer holder WH1 (WH2) is mounted on wafer stage WST, a stage side electrical contact 55 electrically connected to a power supply 71 external to wafer stage WST is arranged. Accordingly, as shown in FIG. 3B, because voltage is applied to wafer holder WH1 (WH2) by power supply 71 in a state where holder side electrical contact 36 and stage side electrical contact 55 are in contact, electrostatic force occurs between wafer holder WH1 (WH2) and wafer W, and wafer W can be held against the wafer holder by the electrostatic force on the upper surface of wafer holder WH1 (WH2). Incidentally, although it is not shown in FIG. 3B, coil 202 and a power supply to apply electrical current to coil 202 are electrically connected.

Further, on the four corner sections on the upper surface of wafer holder WH1 (WH2), a reference mark MK is arranged. Reference mark MK will be described later in the description.

Wafer stage WST described above can be moved to a position (the position shown by reference letters WST′) shown by a phantom line (double dotted chain line) in FIG. 1, in a state holding wafer holder WH1 (or WH2). In the state where wafer stage WST is positioned at position WST′, wafer holder WH1 (or WH2) can be carried between wafer stage WST and wafer exchange section 24A by first holder carrier robot 26, and further, wafer holder WH2 (or WH1) can be carried between wafer stage WST and wafer exchange section 24B.

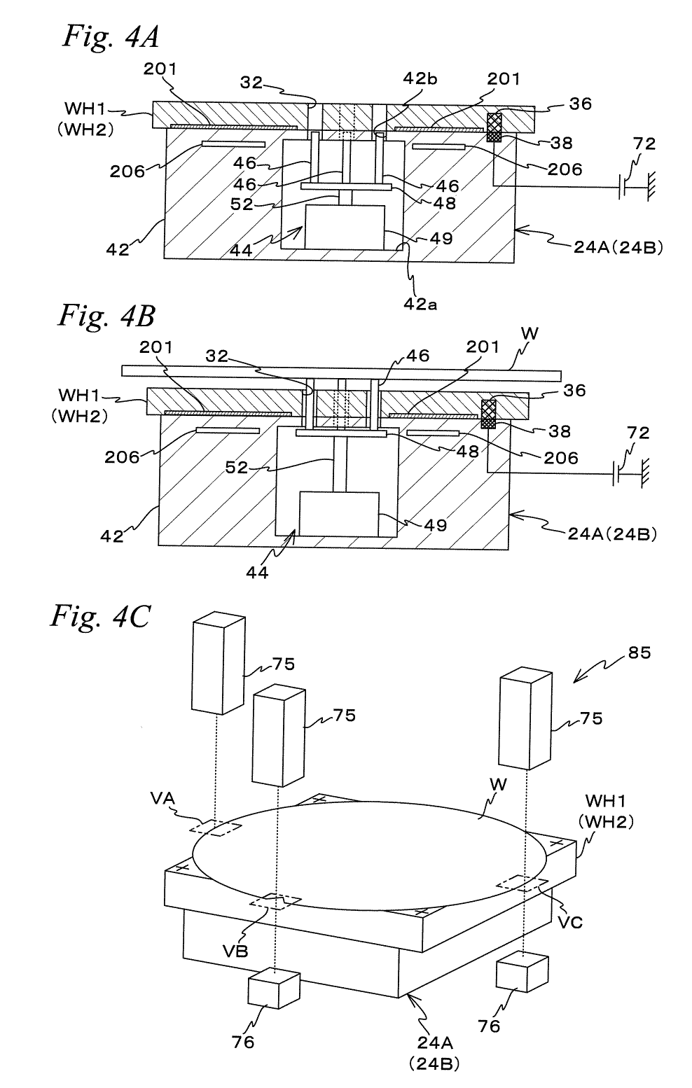

Wafer exchange sections 24A and 24B have the same shape/configuration. As shown in a partially cross-sectioned view in FIG. 4A, wafer exchange section 24A (24B) is equipped with a main body section 42 which is a rectangular solid, a center up section 44 arranged inside main body section 42, and a coil 206. As shown in FIG. 4A, wafer holders WH1 and WH2 can be mounted on the upper surface of wafer exchange section 24A (24B), and wafer holder WH1 (or WH2) can be chucked by magnetic force (electromagnetic force), similar to wafer stage WST. Incidentally, also in FIG. 4, a power supply to apply electrical current to coil 206 is not shown. Incidentally, in the case heat which occurs when applying current to coil 206 becomes a problem, it is possible to place a temperature control device on wafer stage WST and wafer exchange sections 24A and 24B, appropriately. As the temperature control device, for example, a temperature control device of a liquid method which uses liquid such as pure water and Fluorinert, a temperature control device which uses a Peltier element and a heater, or a temperature control which uses gas can be used.

Incidentally, in the embodiment, wafer holder WH1 (WH2) is fixed to wafer stage WST and wafer exchange sections 24A and 24B by a fixed mechanism which uses magnetic force, however, instead of this, a fixed mechanism that uses other forces such as mechanical force and electrostatic force can also be employed. For example, as a fixed mechanism which uses electrostatic force, a fixed mechanism which uses electrostatic force as described in, U.S. patent application publication No. 2005/0286202 description previously described can be used.

As shown in FIG. 4A, main body section 42 has a hollow section (space) 42a inside, and on the upper surface of main body section 42, three through-holes 42b which makes space 42a communicate with the outside are formed. The placement of the three through-holes 42b approximately agrees with the placement of through-holes 32 formed in wafer holder WH1 (WH2). Further, on the upper surface of main body section 42, although it is not shown, a temperature control device is arranged. This temperature control device includes a temperature control device which uses a Peltier element and a heater, a cool plate, a liquid temperature control device and the like, and cools wafer holder WH1 (WH2) mounted on main body section 42, and adjusts it to a predetermined temperature.

Center up section 44 includes a drive mechanism 49 arranged within space 42a, a shaft section 52 connecting to drive mechanism 49, a plate member 48 fixed to the upper end (the +Z end) of shaft section 52, and three center pins 46 fixed on the upper surface of plate member 48 with the Z-axis direction serving as the longitudinal direction.

Shaft section 52 is driven reciprocally (moved vertically) in the Z-axis direction, and is also finely driven in the X-axis direction, the Y-axis direction, and the θz direction by drive mechanism 49. The placement of the three center pins 46 generally agrees with through-holes 42b formed in main body section 42 and through-holes 32 formed in wafer holder WH1 (WH2). The diameter of each center pin 46 is set smaller than the diameter of each of the through-hole 42b and 32. Therefore, each center pin 46 can be finely moved in the X, Y, and θz directions even in a state (refer to FIG. 4B) where each center pin 46 is inserted into through-holes 42b and 32. Further, as shown in FIG. 4B, the size of each center pin 46 in the Z-axis direction is about the size where the upper end protrudes from the upper surface of wafer holder WH1 (WH2) when shaft section 52 is positioned at the top side, and in the protruded state, each center pin 46 can support wafer W from the lower side. And, by shaft section 52 being driven downward by drive mechanism 49 in a state where the wafer is supported from below as in FIG. 4B, wafer W is mounted on wafer holder WH1 (WH2).

In wafer exchange section 24A (24B), an exchange section side electrical contact 38 similar to stage side electrical contact 55 of wafer stage WST previously described is arranged. With exchange device side electrical contact 38, holder side electrical contact 36 comes into contact in a state where wafer holder WH1 (or WH2) is mounted on wafer exchange section 24A (or 24B). Therefore, by the voltage applied to wafer holder WH1 (or WH2) by power supply 72 arranged externally, electrostatic force occurs between wafer holder WH1 (or WH2) and wafer W, and by the electrostatic force, wafer W can be held on the upper surface of wafer holder WH1 (or WH2).

Further, in the vicinity of wafer exchange section 24A (and 24B), a second prealignment device 85 shown in FIG. 4C is arranged. The second prealignment device 85 is an alignment device which detects decentering quantity and rotation quantity of the wafer more precisely than the first prealignment device 16. The second prealignment device 85 includes three illumination devices 75 (e.g., LED and the like) which illuminates a part of the outer edge (the parts shown in reference code VA, VB, VC in FIG. 4C) of wafer W from the +Z side, and three imaging devices 76 (however, the imaging device corresponding to section VA is not shown) arranged at a position facing each of the illumination devices 75 in the vertical direction (the Z-axis direction).

The second prealignment device 85 sends imaging results of the three imaging devices 76 to a controller (not shown). The controller computes the center position (decentering quantity) and the rotation quantity (the shift amount in the rotating direction) of wafer W based on imaging results by imaging device 76, and based on the computation results, drives shaft section 52, plate member 48, and the three center pins 46 in the X, Y, and θz directions via drive mechanism 49, and adjusts the position and the rotation of the wafer within the XY plane held by the three center pins 46.

In this case, because reference mark MK is arranged on the four corner sections of wafer holder WH1 (WH2) as previously described, reference mark MK can be detected with a detection system (not shown) when imaging of the outer circumference of wafer W is performed by the second prealignment device 85 described above. And then, by detecting reference mark MK using an alignment system (not shown) when wafer holder WH1 or WH2 is carried to wafer stage WST later on, detection results of the second prealignment device 85 can be succeeded to exposure apparatus main section 100, with reference mark MK serving as a reference. Accordingly, it becomes possible to carry the wafer holder with high precision, or consequently to perform wafer carriage and wafer alignment with highly precision.

Referring back to FIG. 1, the second holder carrier robot 27 is made up of a horizontal multiple-joint robot (a SCARA robot) that can move vertically (linear movement in the Z-axis direction), and carries wafer holder WH1 (WH2) between wafer exchange section 24B and load lock chamber 30 for holders.

Load lock chamber 30 for holders has a door 65A of vacuum space 40 side and a door 65B of atmospheric space 50 side, and has a platform (not shown) arranged inside on which wafer holder WH1 (or WH2) can be mounted. Load lock chamber 30 for holders can make its inner space into a vacuum or into an atmospheric environment in a state where doors 65A and 65B are closed, and the second holder carrier robot 27 can have access inside from the vacuum space 40 side and an operator can have access inside from the atmospheric space 50 side.

Next, a wafer carrier operation and exposure operation in exposure apparatus 10 having the configuration described above will be described.

First of all, carriage of a wafer (a wafer which is subject to exposure) in atmospheric carrier system 112 and vacuum carrier system 110 will be described, according to FIG. 1. First of all, when the wafer is carried onto wafer delivery section 14 from a C/D (not shown) via a carrier system of the C/D side (not shown), the controller uses atmospheric carrier robot 19 to carry the wafer on wafer delivery section 14 onto turntable 16A of the first prealignment device 16. Then, the controller uses atmospheric carrier robot 19 to carry the wafer into load lock chamber 20A, after adjusting the position and/or rotation of the wafer in the XY direction with the first prealignment device 16. On this carriage, door 61A of load lock chamber 20A is to be in an opened state and door 61B is also to be in a closed state.

Then, an operation is repeatedly performed on a predetermined number of wafers, and at the stage where the predetermined number of wafers are housed in load lock chamber 20A, the controller closes door 61A of load lock chamber 20A and opens door 61B, after making the inside of load lock chamber 20A into a vacuum.

Next, the controller sequentially carries the wafers in load lock chamber 20A into stocker 22A, using vacuum carrier robot 23. Because the inside of stocker 22A is maintained at a predetermined temperature, the wafers carried into stocker 22A are adjusted to the predetermined temperature. Incidentally, at a stage where all the wafers in load lock chamber 20A are carried into stocker 22A, the controller closes door 61B of load lock chamber 20A and sets the inside to an atmospheric pressure state, and then opens door 61A. Accordingly, load lock chamber 20A is set to a state where the next wafer carried from atmospheric carrier system 112 can be carried in.

Next, the carriage of the wafer on which the exposure operation described below has been completed in vacuum carrier system 110 and atmospheric carrier system 112 will be described. Incidentally, the carrier operation of the wafer (the wafer which has been exposed) on which the exposure has been completed is performed in parallel with the carrier operation of the wafer subject to exposure previously described.

First of all, the controller carries the wafer which has been exposed into stocker 22B from within chamber 12 via vacuum carrier robot 23. Further, in a state where door 62B of load lock chamber 20B is open, the controller carries the wafer in stocker 22B into load lock chamber 20B, using vacuum carrier robot 23. Incidentally, when door 62B of load lock chamber 20B is open at the point where the wafer which has been exposed is carried into stocker 22B, the wafer can be carried directly into load lock chamber 20B, without going through stocker 22B.

Then, the operation described above is repeatedly performed on a plurality of wafers that have been exposed, and at the stage where a predetermined number of wafers which have been exposed are housed in load lock chamber 20B, the controller closes door 62B of load lock chamber 20B and after making the inside of load lock chamber 20B into an atmospheric environment, opens door 62A.

Then, the controller sequentially carries the wafers in load lock chamber 20B to wafer discharge section 18, using atmospheric carrier robot 19. The wafer carried to wafer discharge section 18 is carried to the C/D (not shown) by the carrier system of the C/D side (not shown).

The overall exposure operation including the carry-in/carry-out operation of the wafer to wafer stage WST in a state where a predetermined number of wafers are housed in stocker 22A will be described next, based on FIGS. 1, 4B, and 5A to 6B.

The state shown in FIG. 1 is a state where exposure is performed to wafer W held by wafer holder WH1 on wafer stage WST in exposure apparatus main section 100, and wafer holder WH2 is mounted on wafer exchange section 24B.

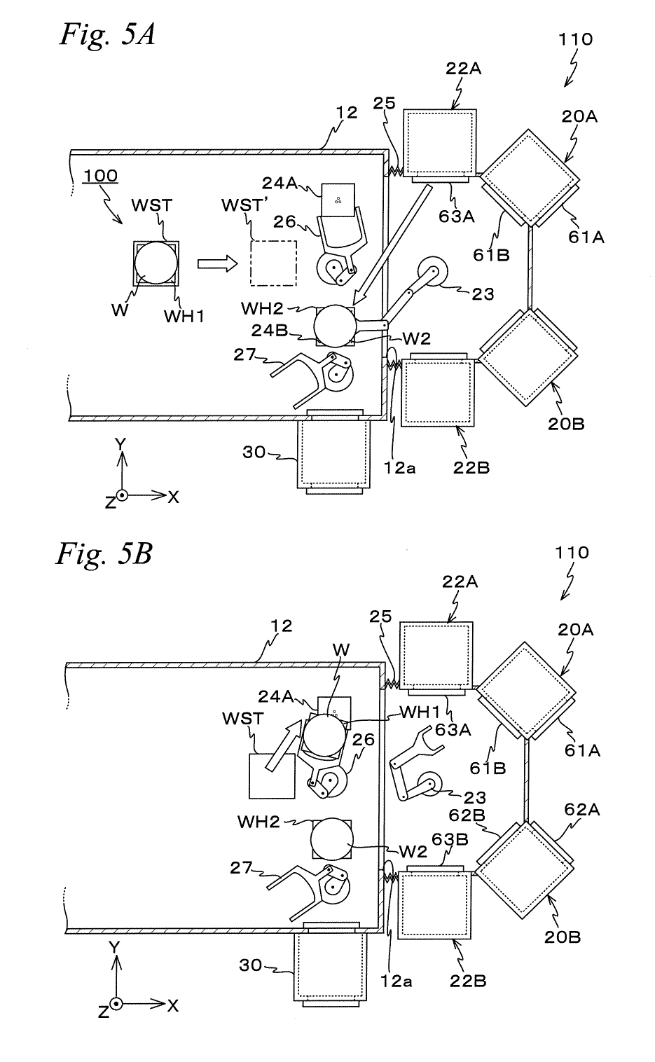

From this state, the controller carries a new wafer (referred to as W2) onto wafer holder WH2 mounted on wafer exchange section 24B from stocker 22A, using vacuum carrier robot 23, as shown in FIG. 5A. Wafer exchange section 24B receives wafer W2 from vacuum carrier robot 23, in a state where the three center pins 46 are projected from the upper surface of wafer holder WH2 as shown in FIG. 4B. Then, wafer exchange section 24B mounts wafer W2 on wafer holder WH2 by making center pins 46 move downward.

At the stage where wafer W2 is mounted on wafer holder WH2 in the manner described above, the controller picks up the image of three points (VA, VB, VC) on the outer edge of wafer W2 via the second prealignment device 85, and computes the center position and rotation quantity of wafer W2. Then, the controller moves shaft section 52 upward and lifts wafer W2 via drive mechanism 49, and moves shaft section 52 in a horizontal plane (in at least one direction of the X-axis direction, the Y-axis direction, and the θz direction) based on the computation results and sets wafer W2 to a desired state. In this state, the controller moves shaft section 52 downward via drive mechanism 49, and mounts wafer W2 on wafer holder WH2 again.

Then, the controller applies voltage by power supply 72 via exchange device side electrical contact 38 arranged in main body section 42 of wafer exchange section 24B and holder side electrical contact 36 arranged in wafer holder WH2, and holds wafer W2 electrostatically on the upper surface of wafer holder WH2. Incidentally, on this electrostatic force, by taking into consideration the case when there is a difference of temperature between wafer W2 and wafer holder WH2, a procedure of mounting wafer W2 on wafer holder WH2 and performing electrostatic force, releasing the force once after a predetermined period of time has passed, and then performing electrostatic force again can be followed so as to prevent deformation of the wafer due to the difference of temperature.

Meanwhile, on the wafer holder WH1 side (exposure apparatus main section 100 side), by the controller, preparatory operations such as reticle alignment, base line measurement (measurement of the distance from the detection center of the alignment system to an optical axis of projection optical system PO) and the like are performed in a predetermined procedure, using an alignment system (not shown). Then, after the preparatory operations, alignment measurement such as the EGA (Enhanced Global Alignment) whose details are disclosed in, for example, U.S. Pat. No. 4,780,617 description and the like is performed, using an alignment detection system (not shown), and position coordinates of all the shot area on wafer W are obtained.

Then, exposure by the step-and-scan method is performed with EUV light EL as the illumination light for exposure. More specifically, the controller moves wafer stage WST to a scanning starting position (acceleration starting position) for exposure of the first shot area according to the positional information of each shot area on wafer W obtained from the results of wafer alignment while monitoring positional information from wafer interferometer 182W, and also moves reticle stage RST to a scanning starting position (acceleration starting position) and performs scanning exposure of the first shot area. On this scanning exposure, the controller synchronously drives reticle stage RST and wafer stage WST as well as controls the speed of both stages so that the velocity ratio of both stages precisely coincides with the projection magnification of projection optical system PO, and performs exposure (transfer of a reticle pattern).

When scanning exposure of the first shot area is completed in the manner described above, the controller performs a stepping operation between shot areas so as to move wafer stage WST to a scanning starting position (acceleration starting position) for exposure of the second shot area. And scanning exposure of the second shot area is performed in a manner similar to the description above. Hereinafter, a similar operation is performed from the third shot area onward. The stepping operation between shot areas and the scanning exposure operation to a shot area are repeated in the manner described above, and the pattern of reticle R is transferred onto all of the shot areas on wafer W by the step-and-scan method.

Now, in the embodiment, because pattern transfer is performed on the wafer held by wafer holders WH1 and WH2, when there is unevenness (such as, for example, the height of the tip of the multiple pin section is uneven) on the wafer holder surface, a phenomenon occurs in which the wafer held by the wafer holder partially warps, imitating the shape of the wafer holder surface. Further, the unevenness of the wafer holder surface is different in every wafer holder. Accordingly, in the embodiment, an adjustment as in the described below is to be performed on exposure.

More specifically, for example, before performing the exposure operation, positional information related to the Z-axis direction (the height direction) of the surface of wafer holders WH1 and WH2 is to be measured at a number of XY positions of wafer holders WH1 and WH2 while being associated with the (x, y) coordinates, and the information is to be stored in a storage device (not shown), respectively. And from the positional information related to the Z-axis direction stored in the storage device, the controller selects the positional information of the wafer holder (the wafer holder located on wafer stage WST) which is to be used for exposure. And then, on exposure, based on the selected positional information related to the Z-axis direction, the controller adjusts the position related to the Z-axis direction of wafer W or reticle R and/or the position related to the X-axis and the Y-axis directions, and also adjust the Z position of wafer W based on detection results of the wafer focus sensor (114a, 114b). In the manner described above, the Z position of wafer W (the irradiation area part of EUV light EL) can be made to coincide with the best image plane (transfer target position) of projection optical system PO with high response, regardless of the wafer holder to be used for exposure.

Incidentally, the measurement of the wafer holder surface in the Z-axis direction (the height direction) can be performed inside exposure apparatus main section 100 using the wafer focus sensor (114a, 114b), or the measurement can be performed beforehand (e.g., on maintenance or the like) by taking out wafer holder WH1, WH2 via load lock chamber 30 outside the exposure apparatus. In the case of performing measurement inside exposure apparatus main section 100, whether exposure is performed using wafer holder WH1 or WH2 can be distinguished by monitoring the position of the wafer holders (or by storing the position in the storage device) (more specifically, the relation between the wafer holder on wafer stage WST and the measurement values (or correction values) can be obtained). Meanwhile, in the case of performing measurement outside the exposure apparatus, for example, the distinction of the wafer holder used for exposure can be made arranging a specific mark or the like on the wafer holder, and using the mark (more specifically, the relation between the wafer holder on wafer stage WST and the measurement values (or correction values) can be obtained).

Incidentally, the measurement points of the wafer holder can be continuous, or it can be discrete. In the case the measurement points are discrete, points between the measurement points can be computed by interpolation. The spacing of the measurement points in this case is to be decided so that values computed by interpolation can sufficiently satisfy the accuracy required in the exposure apparatus.

Incidentally, adjustment related to the Z-axis relation is not limited to the case where adjustment is performed based on the X positional information of the wafer holder surface which has been actually measured, and adjustment can also be performed based on results which have been obtained by actually exposing and developing the wafer. Further, the adjustment related to the Z-axis direction is not limited to the case where the surface of the wafer holder is measured directly, and unevenness information or distortion information of the wafer can be measured in a state where the wafer (or a super flat wafer that has a high degree of flatness) is mounted on wafer holder WH1 or WH2, and adjustment related to the Z-axis direction can be performed based on the information. As for the measurement of distortion information of the wafer, it can be obtained by forming an alignment mark on the wafer, measuring the alignment mark, and obtaining the positional information of the wafer within the XY plane, and then by using the information and the surface position information. Further, the information stored in the storage device is not limited to the unevenness information of the surface of the wafer holder, and the information stored can simply be the position correction amount in the Z-axis direction and/or the X-axis and Y-axis directions. In addition to the explanation above, correction of the inclination of the wafer (rotation in the θx direction and/or the Gy direction) can be performed. Incidentally, the apparatus does not necessarily have to have the function of performing all the position corrections in the X-axis direction, the Y-axis direction, the Z-axis direction, the θx direction, and in the θy direction, and the apparatus can be configured to perform position correction in the necessary directions according to the precision required in the apparatus.

And when the exposure operation is completed in the manner described above, the controller moves wafer stage WST to a position (WST′) shown in a phantom line in FIG. 5A via wafer stage drive system 162.

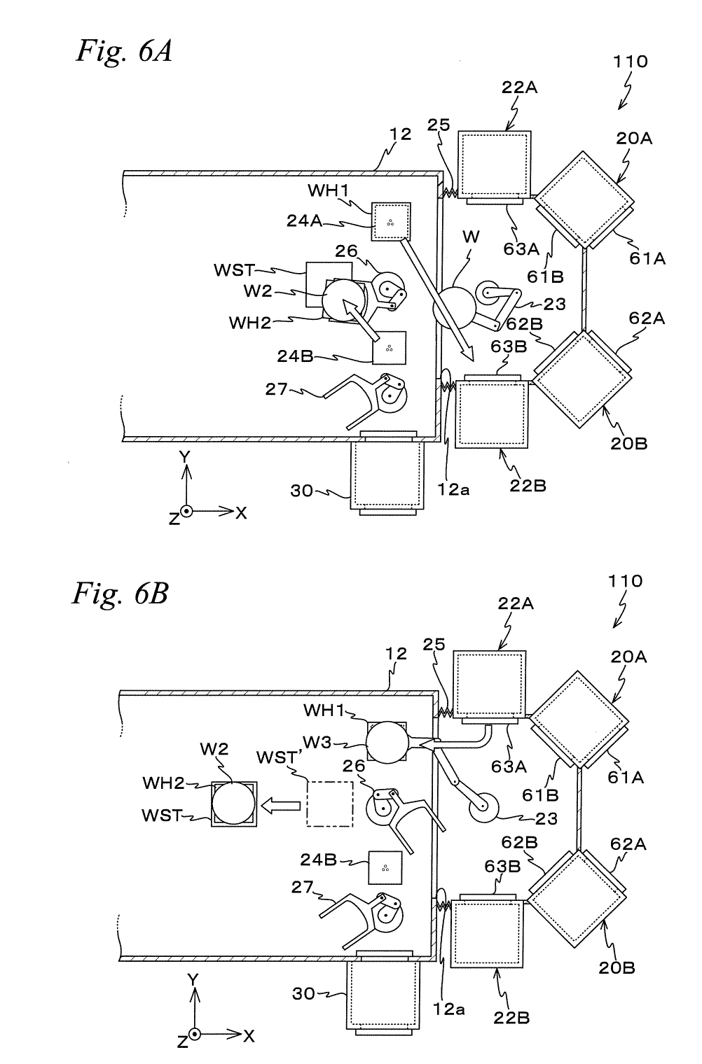

Next, as shown in FIG. 5B, the controller carries wafer holder WH1 which is in a state holding wafer W onto wafer exchange section 24A using the first holder carrier robot 26, and also carries wafer holder WH2 which is in a state holding wafer W2 onto wafer stage WST, as shown in FIG. 6A. Because the carriage of wafer holders WH1 and WH2 can be performed within a short period, in the embodiment, the holding of the wafer by wafer holders WH1 and WH2 during the carriage will be performed using the electrostatic force which remains in wafer holder WH1 or WH2.

Then, as shown in FIG. 6A, the controller carries wafer W which has been exposed on wafer holder WH1 into stocker 22B using vacuum carrier robot 23, and carries a new wafer W3 from stocker 22A onto wafer holder WH1 as shown in FIG. 6B.

After the carriage, the controller performs detection and the like of wafer W3 with the second prealignment device 85 in wafer exchange section 24A, as in the case of wafer W2 previously described, and also performs the alignment operation and exposure operation described above on wafer W2 mounted on wafer stage WST. And then, after the operations above, the parallel processing of the exposure operation using wafer holder WH1 and the exchange operation of the wafer on wafer holder WH2 and the parallel processing of the exposure operation using wafer holder WH2 and the exchange operation of the wafer on wafer holder WH1 are repeated as in the description above, and when the exposure operation has been completed on a predetermined number of wafers, the entire process is completed.

Now, in the case there is foreign materials such as dust or particles on the wafer holder WH1 or WH2 upper surface, when a wafer is mounted on wafer holder WH1 or WH2, the foreign material will be sandwiched between the wafer holder and the wafer, which may affect the degree of flatness of the wafer, and in turn, affect the exposure accuracy. Accordingly, in the embodiment, the detection of whether or not there is a foreign material on the wafer holder and the cleaning of the wafer holder will be performed in the following manner.

The controller mounts a wafer (or a super flat wafer) on wafer holder WH1 (or WH2) so as to detect whether or not there is a foreign material on wafer holder WH1 (or WH2). Then, wafer stage WST is moved within the horizontal plane so that wafer holder WH1 (or WH2) will be located right under projection optical system PO. And then, the controller moves wafer stage WST so that the irradiation area of the wafer focus sensor (114a, 114b) in FIG. 1 moves to cover the entire wafer upper surface, and during the movement, also monitors the detection result of the wafer focus sensor (114a, 114b).

The controller refers to the monitoring results and judges whether or not there is a point where the Z position differs extremely from the surrounding area (also referred to as a “hot spot”), and in the case the controller judges that there is a hot spot (or there is more than a predetermined number), the wafer holder WH1 (or WH2) is carried to wafer exchange section 24B from wafer stage WST using the first holder carrier robot 26, and then is carried using the second holder carrier robot 27 from wafer exchange section 24B into load lock chamber 30 whose door 65A is in an opened state.

Then, the controller closes door 65A of load lock chamber 30, after having made the inside into an atmospheric pressure state, makes the chamber accessible by users from the outside by opening door 65B.

By the arrangement above, the user has access to wafer holder WH1 (or WH2) housed in load lock chamber 30 from outside exposure apparatus 10, and performs cleaning of the upper surface of wafer holder WH1 (or WH2) using a whetstone, a dust-free cloth or the like. And, at the stage when cleaning has been completed, wafer holder WH1 (or WH2) is returned to wafer exchange section 24B in a procedure reverse to the description above.

Incidentally, as load lock chamber 30, a load lock chamber which has a size (internal volume) large enough to simultaneously house the two wafer holders WH1 and WH2 can be employed. By such an arrangement, for example, in the case the judgment was made that there is a foreign material on one of the wafer holders in the foreign material detection operation described above, the two wafer holders can both be cleaned at the same time by carrying both wafer holders into load lock chamber 30.

Further, when an adhesion tendency (more specifically, the tendency related to the number of wafers to be exposed until adhesion of a foreign material occurs, or the tendency related to operation hours of the exposure apparatus until adhesion of a foreign material occurs) of the foreign material was derived by performing the foreign material detection operation of the wafer holder a predetermined number of times, the cleaning of the wafer holder may be performed based on the number of wafers or the operating time of the exposure apparatus, without performing the foreign material detection operation.

As described above, in the embodiment, because the wafer exchange of the wafer on wafer holders WH1 and WH2 is performed in wafer exchange sections 24A and 24B, the exposure operation and the wafer exchange operation can be performed concurrently. Accordingly, even if it takes a relatively long time for wafer exchange due to using the wafer holder by the electrostatic chuck method, it is possible to perform the wafer exchange without stopping the operation of exposure apparatus main section 100, which makes it possible to increase the throughput. Further, according to the embodiment, because a first holder carrier robot 26 carries wafer holder WH1 or WH2 in a state where the wafer is held between exposure apparatus main section 100 and wafer exchange sections 24A or 24B, by carrying one of wafer holders WH1 and WH2 to wafer exchange section 24A or 24B and performing wafer exchange in parallel with the exposure operation or the like of the wafer held by the other of wafer holders WH1 and WH2, it becomes possible to make the temperature of the wafer holder conform to the wafer mounted on the wafer holder. Accordingly, it is possible to employ a configuration that does not have the temperature control mechanism or the like described arranged on wafer stage WST above for performing temperature control of wafer holders WH1 and WH2. To be more specific, for example, if tubes for supplying cooling fluid will not employed in wafer stage WST, it becomes possible to suppress a decrease in position controllability of wafer stage WST due to the drag of the tubes.

Further, according to the embodiment, because vacuum carrier system 110 and chamber 12 are substantially divided regarding vibration, even if the exposure operation in exposure apparatus main section 100 and the wafer carrier operation in vacuum carrier system 110 are performed in parallel, the influence that the wafer carrier operation has on the exposure accuracy of exposure apparatus main section 100 can be suppressed as much as possible.

Further, according to the embodiment, because wafer holder WH1 (WH2) has electrical contact 36, and wafer exchange section 24A (24B) and wafer stage WST have electrical contacts 38 and 55 that supply electric current via electrical contact 36, respectively, it is not necessary to arrange a power supply in wafer holder WH1 (WH2). Accordingly, the weight of wafer holders WH1 and WH2 can be reduced.

Further, in the embodiment, because the area that the wafer holder and the wafer are in contact is set to 20% or less of the area of the surface of the wafer facing the wafer holder when the wafer is held by wafer holders WH1 and WH2, it is possible to move the wafer held on the wafer holder at a high speed within the XY plane, and electrostatic force holds a wafer on a wafer holder and is also possible to reduce the possibility of sandwiching a foreign material between the wafer and the wafer holder.

Further, in the embodiment, because a temperature control device (e.g., a cool plate or the like) for controlling the temperature of wafer holders WH1 and WH2 is arranged in wafer exchange sections 24A and 24B, it is possible to perform exposure with high precision without being affected when possible by the heat that remains in the wafer holder when exposing the wafer.

Incidentally, in the embodiment above, electrical contact 36 was arranged in wafer holders WH1 and WH2, stage side electrical contact 55 was arranged in wafer stage WST, exchange section side electrical contact 38 was arranged in wafer exchange sections 24A and 24B, and electrostatic force of wafer holders WH1 and WH2 was performed by supplying voltage through each electrical contact, however, the present invention is not limited to this, and a power supply (a battery, a capacitor or the like) can be built in directly inside wafer holder WH1 and WH2. In this case, the wafer can be held electrostatically even when wafer holders WH1 and WH2 are carried between wafer stage WST and wafer exchange sections 24A and 24B, therefore, it is possible to carry the wafer holder holding the wafer in a state where the positional shift of the wafer is suppressed as much as possible.

Incidentally, in the embodiment above, the case has been described where wafer holders WH1 and WH2 are configured by a plate-shaped member of a rough square shape in a planar view (when viewed from the +Z direction), however, the present invention is not limited to this, and wafer holders WH1 and WH2 can be configured by a member that has a circular shape in a planar view. Further, the configuration is not limited to the configuration where a plurality of pin sections is arranged on the upper surface of the wafer holder, and a configuration where a plurality of concentric ring-shaped uneven sections is arranged can also be employed.

Incidentally, in the embodiment above, the case has been described where doors 63A and 63B are arranged in stockers 22A and 22B, respectively, however, the configuration is not limited to this, and a configuration of not arranging doors 63A and 63B is also possible so that vacuum carrier robot 23 can have access constantly to stockers 22A and 22B.

Incidentally, in the embodiment above, load lock chamber 30 for holders and the second holder carrier robot 27 used for the holder cleaning were arranged only on the −Y side of wafer exchange section 24B, however, the configuration is not limited to this, and can be arranged on the +Y side of wafer exchange section 24A as well. Accordingly, the user can creatively use such an arrangement, such as by having access to wafer holder WH1 from the +Y side of the load lock chamber and having access to wafer holder WH2 from the −Y side of the load lock chamber.

Further, in the embodiment above, the case has been described where wafer exchange sections 24A and 24B have the second prealignment device 85, however, the present invention is not limited to this, and a prealignment device (mechanism) can be arranged, separately from wafer exchange sections 24A and 24B. Further, in the embodiment above, the case has been described where a temperature control device including the cool plate was arranged in wafer exchange sections 24A and 24B, however, a configuration of not arranging a temperature control device can also be employed. Further, a configuration of not arranging the second prealignment device itself can also be employed.

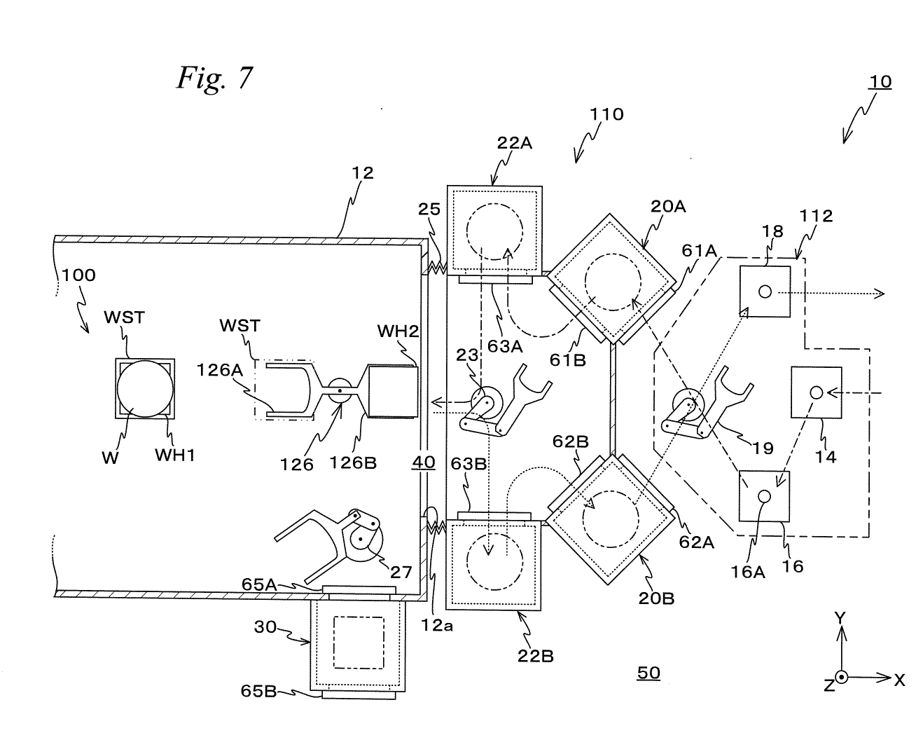

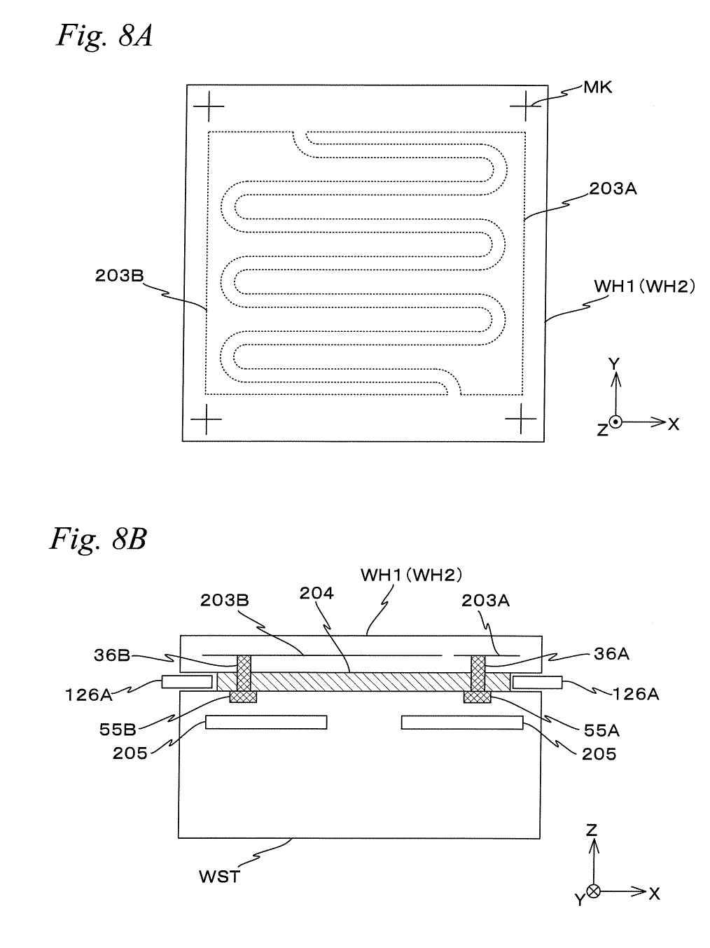

Next, another embodiment of the present invention will be described, based on FIGS. 7, 8A and 8B. As for the configuration same or similar to the embodiment described above, the same reference codes will be used here, and the description thereabout will be omitted.

In the embodiment described above, wafer exchange sections 24A and 24B were arranged, however, in this embodiment, instead of the first holder carrier robot 26 and wafer exchange section 24A and 24B, a third holder carrier robot 126 is arranged which is made to have the function of wafer exchange section 24A (24B). In other words, the third holder carrier robot 126 holds wafer holders WH1 and WH2 longer when compared with the first holder carrier robot.

The third holder carrier robot 126 is a double hand type robot which has hand sections 126A and 126B, and FIG. 7 shows a state where wafer holder WH2 is mounted on hand section 126B. In the embodiment, vacuum carrier robot 23 carries the wafer between load lock chamber 20A and stocker 22A, between stocker 22A and wafer holder WH2 (WH1) mounted on the third holder carrier robot 126, between wafer holder WH2 (WH1) mounted on the third holder carrier robot 126 and stocker 22B, and between stocker 22B and load lock chamber 20B.

As shown by an arrow in FIG. 7, the third holder carrier robot 126 is rotatable around the Z-axis, and is also vertically movable in the Z-axis direction. Further, because holder carrier robot 126 has two hand sections as described above, while wafer holder WH2 is mounted on one hand section, wafer holder WH1 can be mounted on the other hand section. Incidentally, the number of hand sections can be two or more, such as, for example, three.

Wafer stage WST can be move to the position shown by the double dotted chain line in FIG. 7. As shown in FIG. 8, wafer holder WH1 (WH2) has two internal electrodes 203A and 203B. By applying voltage so that the electric potential of each of the two internal electrodes is of a different polarity, it becomes possible to have a sensitive substrate such as the wafer placed on the upper surface. Incidentally, it is possible to place through-holes 32 as in the embodiment previously described, however, in the embodiment, the configuration is employed which does not place through-holes 32.

Further, as shown in FIG. 8B, a magnetic layer 204 is arranged on the bottom side of wafer holder WH1 (WH2). Further, holder side electrical contacts 36A and 36B are arranged, electrically isolated from magnetic layer 204.

In the embodiment, because stage side electrical contacts 55A and 55B arranged in wafer stage WST and holder side electrical contacts 36A and 36B are electrically connected, respectively, when wafer holder WH1 (WH2) is placed on wafer stage WST, it is possible to apply voltage to internal electrodes 203A and 203B from a power supply (not shown). Further, because coil 205 is arranged in wafer stage WST, a magnetic force (electromagnetic force) is generated by applying current to coil 205, and wafer holder WH1 (WH2) having magnetic layer 204 is fixed to wafer stage WST by the magnetic force. Meanwhile, in the case of removing wafer holder WH1 (WH2) from wafer stage WST, the magnetic force can be removed by stopping the supply of current to coil 205. Incidentally, although it is not shown in FIG. 8B, coil 205 and a power supply to apply electrical current to coil 205 are electrically connected.

In the embodiment, as shown in FIG. 7, hand section 126A of the third holder carrier robot 126 moves into the space between wafer holder WH1 (WH2) and wafer stage WST as shown in FIG. 8B at the point where wafer stage WST moves to the position shown by the double dotted chain line, and then, by stopping the supply of current to coil 205 and moving the third holder carrier robot 126 in the +Z direction (upward), the third holder carrier robot 126 lifts wafer holder WH1 from wafer stage WST. Then, by rotating the third holder carrier robot 126 around the Z-axis, positioning wafer holder WH2 which is to be placed next on wafer stage WST, and moving holder carrier robot 126 in the −Z-direction (downward), wafer holder WH2 will be placed on wafer stage WST.

Incidentally, of wafer stage WST, a measurement device for measuring the positional relation between wafer holder WH1 (WH2) and wafer stage WST can be placed separately on the section where wafer holder WH1 (WH2) is mounted, and the exchange wafer holder WH1 (WH2) can be performed while alignment is performed using the measurement device. Further, instead of vertically moving the third holder carrier robot 126, by vertically moving wafer stage WST, the configuration of mounting wafer holder WH1 (WH2) on wafer stage WST or detaching the wafer holder from wafer stage WST is possible.

Further, in the embodiment, in order to mount the wafer on wafer holder WH1 (WH2), the wafer is mounted directly onto wafer holder WH1 (WH2) mounted on holder carrier robot 126 from vacuum carrier robot 23. By placing a measurement device for measuring the position of wafer holder WH1 (WH2) and/or the wafer in the vicinity of the wafer mounting place (the place in FIG. 7 where wafer holder WH2 is located) and controlling the position of vacuum carrier robot 23 and/or the third holder carrier robot 126 based on positional information measured by the measurement device, the mounting position (the position in the X and Y-axis directions) of the wafer to wafer holder WH1 (WH2) can be adjusted.

Further, in the embodiment, in the case wafer holder WH1 (WH2) is carried out from a vacuum environment to an atmospheric environment, wafer holder WH1 (WH2) is carried from the third holder carrier robot 126 to load lock chamber 30 using holder carrier robot 27.

Incidentally, in the case it is necessary to hold the wafer by wafer holder WH1 (WH2) on the third holder carrier robot 126, an electrical contact can be placed in the hand of the third holder carrier robot, and voltage can be applied to internal electrodes 203A and 203B arranged in wafer holder WH1 (WH2) via the electrical contact.

Incidentally, the configuration of exposure apparatus 10 is a mere example, and various kinds of configurations can be employed in the scope not departing from the brief summary of this invention. Further, various kinds of configurations can be combined optionally, or not using a part of the configuration is also possible.

Incidentally, in the embodiment above, the case has been described where the exposure apparatus main section is an exposure apparatus of the single stage type that has a single wafer stage, however, the present invention is not limited to this, and as disclosed in, for example, the pamphlet of International Publication No. 2005/074014 and the like, the present invention can also be applied to an exposure apparatus main section which is equipped with a measurement stage including a measurement member (such as, for example, a reference mark and/or a sensor), separate from the wafer stage. Further, the present invention can also be applied to an exposure apparatus equipped with an exposure apparatus main section of a multi-stage type that has a plurality of wafer stages, as is disclosed in, for example, Kokai (Japanese Unexamined Patent Application Publications) No. 10-163099 and No. 10-214783 (the corresponding U.S. Pat. No. 6,590,634), Kohyo (published Japanese translation of International Publication for Patent Application) No. 2000-505958 (the corresponding U.S. Pat. No. 5,969,441), the U.S. Pat. No. 6,208,407, and the like.

Further, the magnification of the projection optical system in the exposure apparatus main section of the embodiment above is not limited only to the reduction system, but can also either be an equal magnification or a magnifying system.

Incidentally, in each of the embodiments above, the case has been described where an EUV light having the wavelength of 11 nm is used as the exposure light, however, the present invention is not limited to this, and EUV light having a wavelength of 13.5 nm can also be used as the exposure light. In this case, in order to secure reflectivity of around 70% to EUV light having the wavelength of 13.5 nm, it is necessary to use a multilayer film in which molybdenum Mo and silicon Si are alternately layered as a reflection coating of each mirror.

Further, in each of the embodiments above, the laser-excited plasma light source was used as the exposure light source, however, the present invention is not limited to this, and either one of a SOR light source, a betatron light source, a discharged light source, an X-ray laser and the like can also be used.

Further, as the exposure apparatus main section, an exposure apparatus that uses an electron beam or a charged particle beam such as the ion beam can also be employed. Further, while the case has been described where space 40 including main body chamber 12 was made into a vacuum space, besides this, it is possible to make the space into a reduced-pressure environment (a space which is not in a vacuum state but whose pressure is reduced more than that of the atmospheric pressure).

Further, in each of the embodiments above, a reflection type mask (reticle) was used, however, instead of this reticle, an electronic mask (a variable shaped mask) on which a reflection pattern is formed based on the electronic data of the pattern that should be exposed may be used, as is disclosed in, for example, U.S. Pat. No. 6,778,257 description.

In each of the embodiments above, while chamber 12 which is a vacuum chamber was described, the partition wall of chamber 12 and vacuum carrier system 110 can be shared so as to form a single chamber. Further, in the description, in the case of using the expression chamber, it includes the case where the chamber is configured of a plurality of chambers. For example, the reticle stage chamber surrounding the reticle stage, the projection optical system chamber surrounding the projection optical system, the illumination optical system chamber surrounding the illumination optical system, and the light source chamber surrounding the light source can each be an independent chamber. Further, two of the chambers or more can be configured as one chamber. Furthermore, an opening through which the exposure light can pass can be made in each chamber, and a plurality of chambers can be connected so that the exposure light is passable. Further, a thin film for attenuating unnecessary light and/or a thin film for removing unnecessary gas, dust and the like can be formed in the opening. Further, a mechanism such as a gate valve and the like can be placed in the opening.

Further, in each of the embodiments above, the expression exposure apparatus main section was used, however, this means that at least the wafer stage is included.

Incidentally, in each of the embodiments above, bellows 25 is used to prevent vibration from traveling between vacuum carrier system 110 and main body chamber 12, however, vacuum carrier system 110 and main body chamber 12 can be directly connected without using bellows 25.

Incidentally, an object on which a pattern is to be formed (an object subject to exposure to which an energy beam is irradiated) in each of the embodiments above is not limited to a wafer, but may be other objects such as a glass plate, a ceramic substrate, a film member, or a mask blank.

The use of the exposure apparatus is not limited only to the exposure apparatus for manufacturing semiconductor devices, but the present invention can also be widely applied to an exposure apparatus for transferring a liquid crystal display device pattern onto a rectangular glass plate, or to an exposure apparatus for producing organic ELs, thin magnetic heads, imaging devices (such as CCDs), micromachines, DNA chips, and the like. Further, the present invention can be applied not only to an exposure apparatus for producing microdevices such as semiconductor devices, but can also be applied to an exposure apparatus that transfers a circuit pattern onto a glass plate or silicon wafer to produce a mask or reticle used in a light exposure apparatus, an EUV exposure apparatus, an X-ray exposure apparatus, an electron-beam exposure apparatus, and the like.

Incidentally, semiconductor devices are manufactured through the steps of a step where the function/performance design of the wafer is performed, a step where a reticle based on the design step is manufactured, a step where a wafer is manufactured using silicon materials, a lithography step where the pattern formed on the mask (reticle) by the exposure apparatus (pattern formation apparatus) in each of the embodiments above is transferred onto a wafer, a development step where the wafer that has been exposed is developed, an etching step where an exposed member of an area other than the area where the resist remains is removed by etching, a resist removing step where the resist that is no longer necessary when etching has been completed is removed, a device assembly step (including processes such as a dicing process, a bonding process, and a packaging process), inspection steps and the like. In this case, because the exposure apparatus in the embodiment above is used in the lithography step, the productivity of highly integrated devices can be improved.

Incidentally, the disclosures of the various publications, the pamphlets of the International Publications, and the U.S. patent application Publication descriptions and the U.S. patent descriptions that are cited in each of the embodiments above and related to exposure apparatuses and the like are each incorporated herein by reference.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure apparatus that exposes an object with an energy beam and forms a pattern on the object, the apparatus comprising:
an object carrier system which carries an object under a reduced-pressure environment;
an object stage on which a holding device that holds the object is mounted under a reduced-pressure environment; and
a holding device carrier system which temporarily holds the holding device that holds the object and can receive/pass the object from/to the stage under a reduced-pressure environment.

2. The exposure apparatus according to claim 1 wherein
the holding device carrier system can receive/pass the holding device alone from/to the object stage.

3. The exposure apparatus according to claim 1, the apparatus further comprising:
an object exchange section on which the holding device is temporarily placed to perform object exchange on the holding device under a reduced-pressure environment.

4. The exposure apparatus according to claim 3 wherein
the object exchange section has a temperature control device which adjusts the temperature of the holding device.

5. The exposure apparatus according to claim 3 wherein
the object exchange section has a detection system which detects a position of the object.

6. The exposure apparatus according to claim 3 wherein
the object stage and the object carrier system are substantially divided regarding vibration.

7. The exposure apparatus according to claim 3 wherein
the holding device has an electrostatic chuck to hold the object by electrostatic force.

8. The exposure apparatus according to claim 7 wherein
the holding device has an electrical contact to apply voltage to the electrostatic chuck, and
in the object exchange section, a voltage applying device which applies voltage to the electrostatic chuck via the electric contact is arranged.

9. The exposure apparatus according to claim 3 wherein
in the reduced-pressure environment, there is a plurality of holding devices.

10. The exposure apparatus according to claim 9, the apparatus comprising:
a plurality of the object exchange sections, wherein
in parallel with exposure being performed using one holding device under the reduced-pressure environment, exchange of an object held by the other holding device is performed in the object exchange section.

11. The exposure apparatus according to claim 9, the apparatus further comprising:
a controller that at least controls exposure of the object, wherein
the controller has correction data for each of a plurality of holding devices and selects the correction data according to the holding device used for exposure.

12. The exposure apparatus according to claim 11 wherein
the correction data include data related to unevenness of the holding device surface.

13. The exposure apparatus according to claim 11 wherein
the correction data include data related to position correction amount of a holding device.

14. The exposure apparatus according to claim 1 wherein
the holding device has an electrostatic chuck to hold the object by electrostatic force.

15. The exposure apparatus according to claim 14 wherein
the holding device has an electrical contact to apply voltage to the electrostatic chuck, and
in the holding device carrier system, a voltage applying device which applies voltage to the electrostatic chuck via the electric contact is arranged.

16. The exposure apparatus according to claim 14 wherein
the holding device has an electrical contact to apply voltage to the electrostatic chuck, and
in the object stage, a voltage applying device which applies voltage to the electrostatic chuck via the electric contact is arranged.

17. The exposure apparatus according to claim 14 wherein
while the holding device carrier system carries the holding device which is in a state holding the object between the object exchange section and the object stage, the holding device holds the object by electrostatic force which remains in the electrostatic force mechanism.

18. The exposure apparatus according to claim 14 wherein
the holding device has a voltage applying device which applies voltage for electrostatic force.

19. The exposure apparatus according to claim 14 wherein
when the holding device holds the object, an area where the holding device and the object come into contact is to be 20% or less of an area of a surface where the object faces the holding device.

20. The exposure apparatus according to claim 1 wherein
in the reduced-pressure environment, there is a plurality of holding devices.

21. The exposure apparatus according to claim 20 wherein
The holding device carrier system can hold at least two of the holding devices simultaneously, and
in parallel with exposure being performed using one holding device under the reduced-pressure environment, exchange of an object held by the other holding device is performed in the holding device carrier system.

22. The exposure apparatus according to claim 20, the apparatus further comprising:
a controller that at least controls exposure of the object, wherein
the controller has correction data for each of the plurality of holding devices and selects the correction data according to the holding device used for exposure.

23. The exposure apparatus according to claim 22 wherein
the correction data include data related to unevenness of the holding device surface.

24. The exposure apparatus according to claim 22 wherein
the correction data include data related to position correction amount of a holding device.

25. The exposure apparatus according to claim 1 wherein
the reduced-pressure environment is formed inside of an enclosed space which is at least partly formed by a chamber.

26. The exposure apparatus according to claim 25 wherein
in the chamber, a discharge opening is arranged to carry out the holding device outside the reduced-pressure environment.

27. A device manufacturing method, including:
exposing a substrate using the exposure apparatus according to claim 1; and
developing a substrate which has been exposed.
